(19) United States
(12) Patent Application Publication
(10) Pub. No.: US 2023/0227286 A1
(43) Pub. Date: Jul. 20, 2023

(54) ELEVATOR LEVEL WARNING SYSTEM AND METHODS OF USE THEREOF

(71) Applicant: Electronic Controls Inc., Cape Canaveral, FL (US)

(72) Inventors: Walter Heidt Barnes, Merritt Island, FL (US); Michael Rose, Orange City, FL (US); Frank Gozukizil, San Diego, CA (US)

(73) Assignees: Frank Gozukizil, San Diego, CA (US); Electronic Controls Inc., Cape Canaveral, FL (US)

(21) Appl. No.: 18/096,689

(22) Filed: Jan. 13, 2023

Related U.S. Application Data
(60) Provisional application No. 63/266,814, filed on Jan. 14, 2022.
(60) Provisional application No. 63/409,366, filed on Sep. 23, 2022.

(51) Int. Cl. B66B 1/34; B66B 5/02

(52) U.S. Cl. CPC B66B 1/3492; B66B 5/02

(57) ABSTRACT

An elevator level warning system is provided, along with methods of use thereof. An elevator level warning system may include a controller, a laser, a sensor, and a reflector. The reflector may be a structured reflector. The elevator level warning system may also include a sensor board. The elevator level warning system may also include an indicator. The elevator level warning system may be used with an elevator system. The elevator level warning system may be used to detect that-and/or warn users that-a front cab-floor edge and a landing plane are misaligned and have a drop between them of greater than a threshold distance.

### CROSS-REFERENCE TO RELATED APPLICATIONS

This application claims priority to U.S. Provisional Pat. Application Serial No. 63/266,814, titled ELEVATOR LEVEL WARNING SYSTEM and filed on Jan. 14, 2022; the specification, drawings, and claims thereof are incorporated herein by reference in their entirety. This application also claims priority to U.S. Provisional Pat. Application Serial No. 63/409,366, titled ELEVATOR LEVEL WARNING SYSTEM AND METHODS OF USE THEREOF and filed on Sep. 23, 2022; the specification, drawings, claims, and appendixes thereof are incorporated herein by reference in their entirety.

### FIELD OF INVENTION

This disclosure relates generally to elevator electronics, in particular, methods and systems for monitoring the leveling of elevators and elevator doors and for warning users of improper levelling. Uses for this apparatus may include, but are not limited to, preventing dangerous conditions due to operation of, ingress to, or egress from an elevator cab when a floor of an elevator is not aligned with a floor of a building.

### BACKGROUND

Elevators are a mode of transferring individuals and cargo in multiple-level buildings. Elevator cars are operated either by a hoisting machine or by hydraulic systems, which are configured to move the elevator car (or “cab” or “cabin”) in an elevator shaft (or “hoistway”) between landings. When the elevator car is arriving at a landing, the elevator car decelerates and stops at the assigned landing. To improve the accuracy of stopping the elevator car at the landing, a leveling system is used.

During the leveling operation, the elevator car is allowed to move into an unlocking zone (e.g., an area extending from above and below a floor level of the landing), in which the elevator car floor must be in order to enable the elevator door to be unlocked. Re-leveling of the elevator car is an operation that is performed after the elevator car is stopped, allowing the elevator car to be corrected during loading or unloading (if necessary).

European standards for the speed limits for leveling and re-leveling are defined. For example, in the European Committee for Standardization’s (“CEN”) European Standards EN 81-1 (Safety rules for the construction and installation of lifts - Part 1: Electric lifts) and EN 81-20 (Safety rules for the construction and installation of lifts - Lifts for the transport of persons and goods - Part 20: Passenger and goods passenger lifts), the speed limit: (1) for leveling with door(s) open is 0.8 meters-per-second (“m/s”); and (2) for re-levelling with door(s) open is 0.3 m/s. According to another example, in the American Society of Mechanical Engineers’s (“ASME”) A17.1 / CSA B44 Safety Code for Elevators and Escalators (the “ASME Standard”), the speed limit for leveling and re-leveling with door(s) open is 0.75 m/s. Furthermore, under Section 2.19 of the ASME Standard—i.e., the Unintended Car Movement Protection (“UCMP”) requirement-the elevator car shall be stopped within a predetermined distance from the landing if the elevator car moves away from the unlocking zone with an open door.

A problem with the leveling and re-leveling is that the Americans with Disabilities Act (“ADA”) (and its implementing regulations and guidances) allows for up to a 0.5-inch (“in.”) distance in the unlocking zone. In an exchange of accuracy for speed, the common 0.5-in. distance results in a tripping hazard—as evidenced by the many lawsuits that attest to the many existing tripping hazards. Other contributing factors include the stretching of the suspension means (e.g., ropes, belts, and other suspension means). Leveling issues affecting hydraulic elevators include: oil leaks in the operating valves; pipe joints; pipe ruptures due to the wrong types of pipes that might not be able to withstand the high pressures produced by the system (e.g., pipes rated according to the American National Standards Institute’s (“ANSI”) various Schedules 40 and Schedules 80 rupture at different pressures); underground corrosion on piping and cylinders (often due to electrolysis); cylinder corroding due to high water-tables; leaking piston seals at the cylinder head; hydraulic oil temperatures (oil temperature affects the oil viscosity, which affects the leveling of hydraulic elevators); and other issues. Both systems are affected by such things as: the settling of buildings; the heat of day and the cool of night; and rains that cool buildings within seconds. For example, in Florida, it is common for the temperature of building-structures to drop from 120° F. (°F) down to 60° F.

The industry needs a device to warn the public using the elevator when the elevator floor is misleveled.

The background of this invention is further explained in U.S. Provisional Pat. Application Serial No. 63/266,814, titled ELEVATOR LEVEL WARNING SYSTEM and filed on Jan. 14, 2022. The background of this invention is also further explained in U.S. Provisional Pat. Application Serial No. 63/409,366, titled ELEVATOR LEVEL WARNING SYSTEM AND METHODS OF USE THEREOF and filed on Sep. 23, 2022.

### SUMMARY OF THE INVENTION

The present disclosure relates to elevator level warning system that, among other things, checks for misleveling when an elevator door opens. If there is misleveling, then the system warns a user of the misleveling.

The present disclosure describes an elevator level warning system and methods of use thereof. In one embodiment, an elevator level warning system is disclosed including: a controller coupled to and powered by a power source; a sensor board coupled to the controller and having at least one sensor mount connected both to a laser that is capable of producing a laser beam and to a sensor that is capable of sensing the laser beam; and a reflector capable of reflecting the laser beam to the sensor, wherein the reflector is oriented with respect to the laser and sensor such that: (A) when a drop between the reflector and the sensor is less than a threshold distance, (1) the reflector substantially reflects the laser beam to the sensor and (2) the sensor senses the laser beam; and, (B) when the drop is not less than the threshold distance, (1) the reflector does not substantially reflect the laser beam to the sensor and (2) the sensor does not sense the laser beam.

In another embodiment, an elevator level warning system, for use with an elevator system having a landing (which defines a landing plane and has a landing front edge) and a front cab-floor edge, is disclosed including: a controller coupled to and powered by a power source; a sensor board coupled to the controller and having at least one sensor mount connected both to a laser that is capable of producing a laser beam and to a sensor that is capable of sensing the laser beam; and a reflector capable of reflecting the laser beam to the sensor; wherein (1) the laser and sensor are positioned with respect to the front cab-floor edge, (2) the reflector is positioned with respect to the landing front edge, and (3) the reflector is oriented with respect to the laser and sensor, such that: (i) when a drop between the front cab-floor edge and the landing plane is less than a threshold distance, (A) the reflector substantially reflects the laser beam to the sensor and (B) the sensor senses the laser beam; and, (ii) when the drop is not less than the threshold distance, (A) the reflector does not substantially reflect the laser beam to the sensor and (B) the sensor does not sense the laser beam.

In another embodiment, a structured reflector, for use in an elevator level warning system, is disclosed including: a reflecting surface having a height and capable of reflecting a laser beam; a first oblique surface; and a first front non-reflecting surface connected to the reflecting surface by the first oblique surface.

### BRIEF DESCRIPTION OF THE DRAWINGS

The following drawings are attached to—and form a portion of-this disclosure:

FIG. 1 is a view of an elevator system, as leveled.

FIG. 2A is a view of an elevator system, as misleveled.

FIG. 2B is a view of an elevator system, as misleveled.

FIG. 3 is a schematic view of an elevator level warning system.

FIG. 4 is a partial side view of an elevator level warning system and an elevator system, as leveled.

FIG. 5 is a partial side view of an elevator level warning system and an elevator system, as misleveled.

FIG. 6 is a partial side view of an elevator level warning system and an elevator system, as misleveled.

FIG. 7 is a partial side view of an elevator level warning system and an elevator system, as misleveled.

FIG. 8A is a perspective view of a structured reflector.

FIG. 8B is a top view of a structured reflector.

FIG. 8C is a front view of structured reflector.

FIG. 8D is a side view of a structured reflector.

### DEFINITIONS

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. For brevity or clarity, well known functions or constructions may not be described in detail.

The terms “about” and “approximately” shall generally mean an acceptable degree of error or variation for the quantity measured in light of the nature or precision of the measurements. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a,” “an,” and “the” are intended to include the plural forms as well, unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The terms “connected to,” “in connection with,” “in communication with,” or “connecting” one or more other parts refer to any suitable connection or communication, including mechanical connection, electrical connection (e.g., one or more wires), or signal-conducting channel (e.g., Bluetooth®, Near-Field Communication (NFC), or other inductive coupling or radio-frequency (RF) link).

The term “processor” may include one or more processors having processing capability necessary to perform the processing functions described herein, including but not limited to hardware logic, computer readable instructions running on a processor, or any suitable combination thereof. A processor may run software to perform the operations described herein, including software accessed in machine readable form on a tangible non-transitory computer readable storage medium, as well as software that describes the configuration of hardware such as hardware description language (HDL) software used for designing chips.

The term “memory” may refer to a tangible or non-transitory storage medium. Examples of tangible (or non-transitory) storage media include disks, thumb drives, and memory, etc., but do not include propagated signals. Tangible computer readable storage media include volatile and non-volatile, removable and non-removable media, such as computer readable instructions, data structures, program modules, or other data. Examples of such media include RAM, ROM, EPROM, EEPROM, SRAM, flash memory, disks or optical storage, magnetic storage, or any other non-transitory medium that stores information that is accessed by a processor or computing device.

It is to be understood that any given elements of the disclosed embodiments of the invention may be embodied in a single structure, a single step, or the like. Similarly, a given element of the disclosed embodiment may be embodied in multiple structures, steps, or the like.

The following description illustrates and describes the processes, machines, manufactures, and other teachings of the present disclosure. The disclosure shows and describes only certain embodiments of the processes, machines, manufactures, and other teachings disclosed; but as mentioned above, it is to be understood that the teachings of the present disclosure are capable of use in various other combinations, modifications, and environments and are capable of changes or modifications within the scope of the teachings of this disclosure, commensurate with the skill and knowledge of a person having ordinary skill in the relevant art. The embodiments described are further intended to explain certain best modes known of practicing the processes, machines, manufactures, and other teachings of the disclosure and to enable others skilled in the art to utilize the teachings of the disclosure in such, or other, embodiments and with the various modifications required by the particular applications or uses. Accordingly, the processes, machines, manufactures, and other teachings of the present disclosure are not intended to limit the exact embodiments and examples disclosed herein. Any section headings herein are provided only for consistency with the suggestions of 37 C.F.R. § 1.77 or otherwise to provide organizational cues. These headings shall not limit or characterize the invention(s) set forth herein.

### DETAILED DESCRIPTION

As described in more detail below, elevator level warning systems and methods for using elevator level warning systems have been developed by the inventors. In addition to the description herein and in the accompanying drawings, further detail is contained in U.S. Provisional Pat. Application Serial No. 63/266,814, titled ELEVATOR LEVEL WARNING SYSTEM and filed on Jan. 14, 2022; the specifications, drawings, claims, and appendixes thereof are incorporated herein by reference in their entirety. In addition to the description herein and therein and in the accompanying drawings, still further detail is contained in U.S. Provisional Pat. Application Serial No.63/409,366, titled ELEVATOR LEVEL WARNING SYSTEM AND METHODS OF USE THEREOF and filed on Sep. 23, 2022; the specifications, drawings, claims, and appendixes thereof are incorporated herein by reference in their entirety. While embodiments of the elevator level warning system and methods for using an elevator level warning system for use with elevators are generally discussed and illustrated, variations could be advantageously used in many types of environments or vehicles. In other words, the teachings of this disclosure may be advantageous in other classes of transport, including other modes of cable transportation and modes of rail transportation.

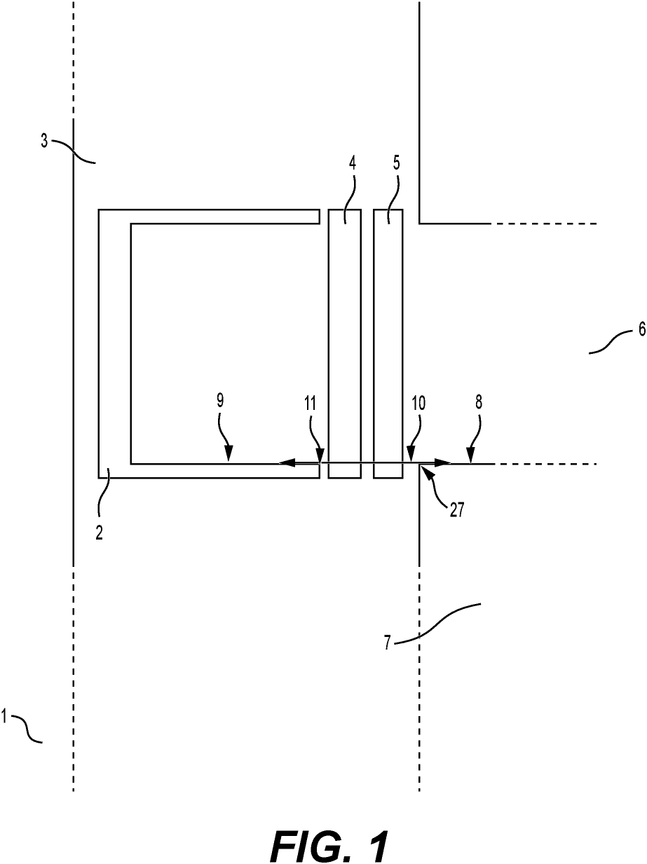

FIG. 1 is a view of an elevator system 1, as leveled. The elevator system has a cab 2 (or “car”) in a hoistway 3 (or “shaft”). The cab 2 has a cab door 4. The cab 2 has a cab floor 9. The cab floor 9 has a front cab-floor edge 11. The elevator system 1 has a hallway door 5 located at each story 6 of the building 7 in which the elevator system 1 is installed.

The hallway door 5 opens onto a landing 8. In some embodiments, as shown in FIG. 1, the landing 8 is a floor of a hallway or foyer in the building 7. In other embodiments, the landing 8 might be a raised platform or the floor of a second elevator cab. The landing has a landing front edge 27. The landing defines a landing plane 10. The landing plane 10 is a horizontal plane (i.e., a plane to which the local pull of gravity is substantially normal). Specifically, the landing front edge 27 is substantially within the landing plane 10.

In the state shown in FIG. 1, the elevator system 1 is “leveled”-i.e., the front cab-floor edge 11 is positioned in the landing plane 10. This is an idealized status, rarely achieved in reality, but nominally approximated by most properly function elevators most of the time.

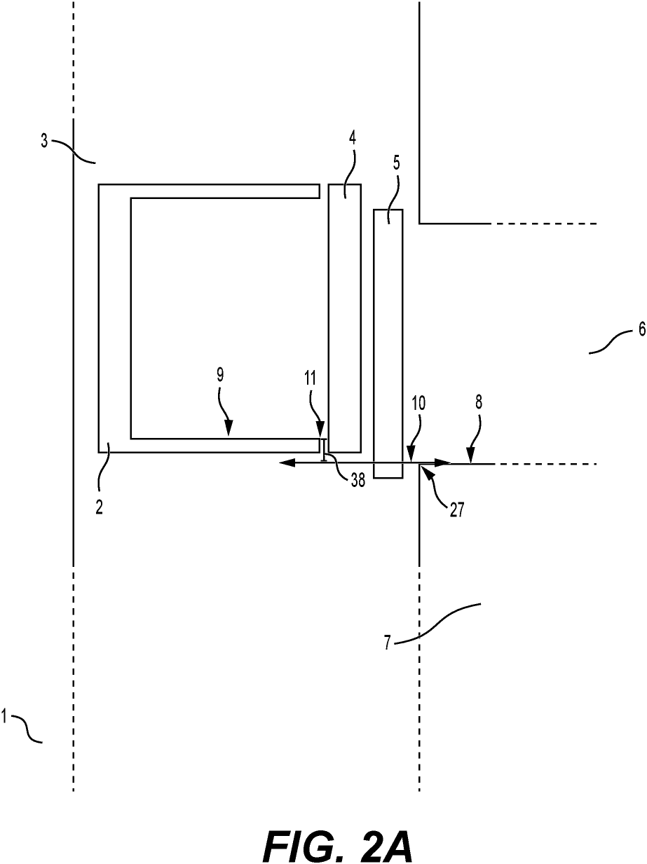

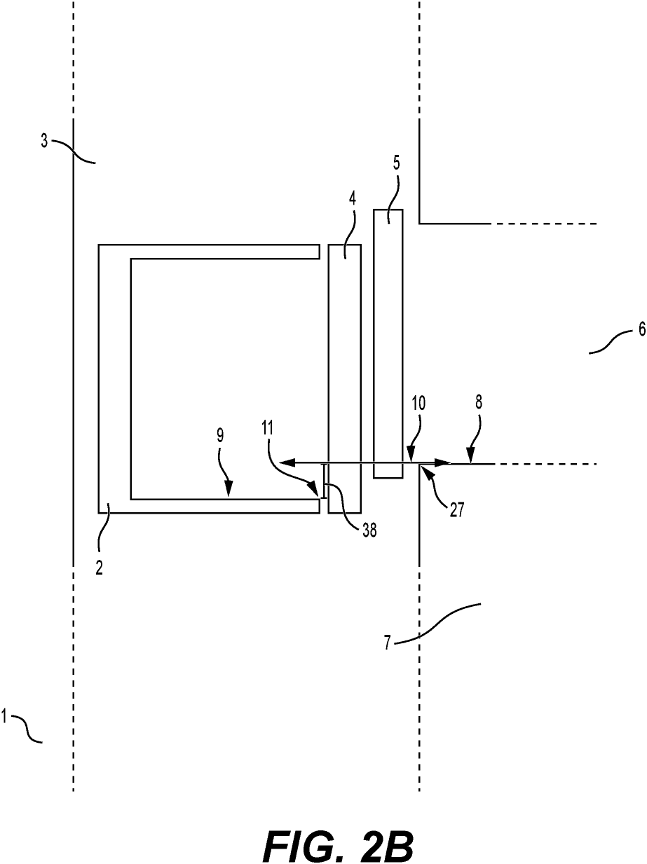

FIG. 2A is a view of an elevator system 1, as misleveled. In this disclosure, the term “misleveled” means that the front cab-floor edge 11 is not positioned in the landing plane 10. In FIG. 2A the front cab-floor edge 11 is above the landing plane 10. This might create a tripping hazard for a user entering the cab 2 and a misstep hazard for a user exiting the cab 2. The absolute value of the vertical (i.e., in the local direction of gravity) distance between the front cab-floor edge 11 and the landing plane is the drop 38. The drop 38 is one effective measure of the degree of misleveling of the elevator system 1.

FIG. 2B is a view of an elevator system 1, as misleveled. In FIG. 2B the front cab-floor edge 11 is below the landing plane 10. This might create a tripping hazard for a user exiting the cab 2 and a misstep hazard for a user entering the cab 2.

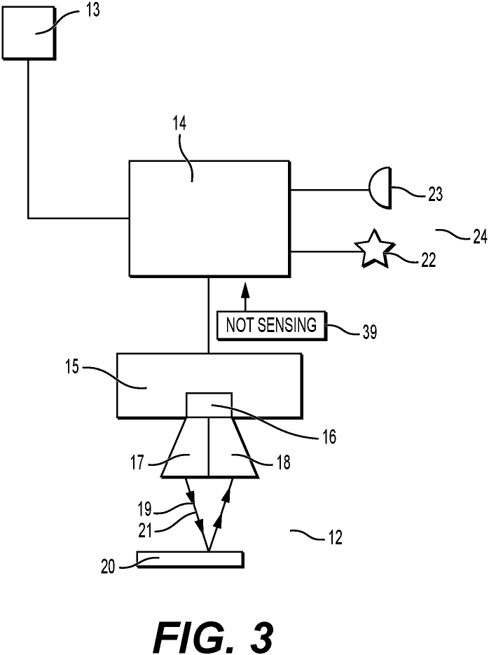

FIG. 3 is a schematic view of an elevator level warning system 12. The elevator level warning system 12 has a power source 13. The power source 13 is any suitable source of electrical power. The elevator level warning system 12 has a controller 14. The controller 14 is a central processing unit (“CPU”) of the elevator level warning system 12 and is coupled to and powered by the power source 13.

The controller 14 is coupled to a sensor board 15. The sensor board 15 has at least one sensor mount 16. In the embodiment shown in FIG. 1, the sensor board has one sensor mount 16. In other embodiments, the sensor board 15 has other numbers of sensor mounts-e.g., two sensor mounts, three sensor mounts, four sensor mounts, five sensor mounts, or six sensor mounts.

To each sensor mount 16 is connected a laser 17 and a sensor 18. The laser 17 produces a laser beam 19. The laser 17 produces a suitable laser beam—for example, a frequency-modulated laser beam, an amplitude-modulated laser beam, a continuous-wave laser beam, or a pulsed laser beam. In some embodiments, the laser beam 19 is unique—for example, by its modulations—to the laser 17. In some embodiments, instead of a laser and a sensor, the sensor mount is connected to an emitter (e.g., an infrared emitter) and a detector (e.g., an infrared detector). While this specification generally describes elevator level warning systems having a laser and a sensor, elevator level warning systems having any suitable emitter and/or any suitable detector could be advantageously used according to the disclosures herein.

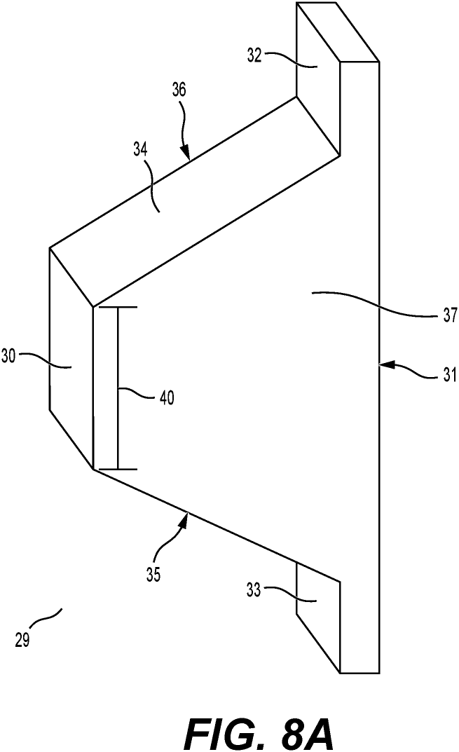

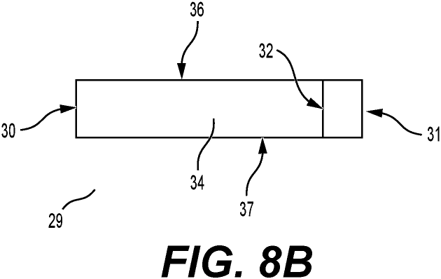

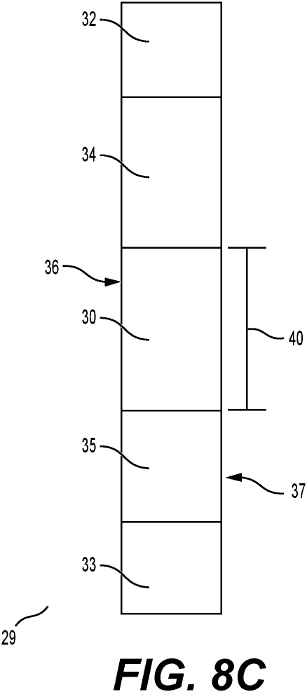

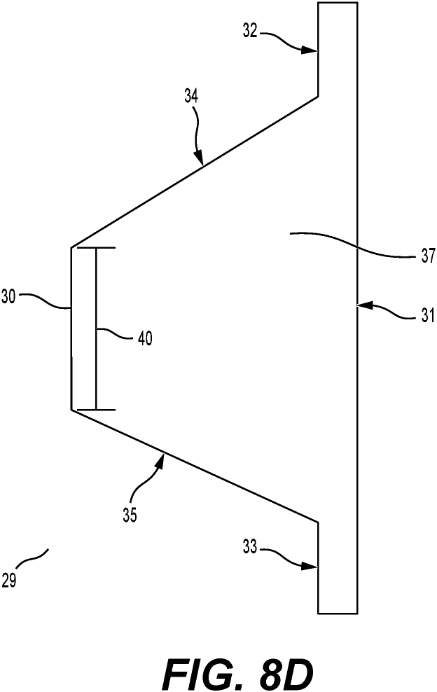

The elevator level warning system 12 has at least one reflector 20. The reflector 20 is any suitable reflector of the laser beam 19. The reflector 20 is placed such that the laser beam 19 will fall on the reflector 20. (That is, the reflector is optically coupled to the laser 17.) The reflector 20 is oriented such that, when the laser beam 19 falls on the reflector 20, the reflector 20 reflects the laser beam 19 to the sensor 18. (That is, the sensor 18 is optically coupled to the reflector 20 and thus to the laser 17.) In some embodiments, the reflector 20 is a structured reflector (described in detail below with reference to FIGS. 8A, 8B, 8C, and 8D).

The sensor 18 is any suitable sensor of the laser beam 19. The sensor 18 detects the laser beam 19. In some embodiments, the sensor 18 is specifically tuned to sense the laser beam 19 substantially to the exclusion of other light sources (e.g., of other lasers or of sunlight). That can be accomplished by tuning the sensor 18 to sense a laser beam having the specific modulations of laser beam 19. In some embodiments, the sensor 18 detects an amplitude 21 of the laser beam.

While the sensor 18 senses the laser beam 19, the elevator level warning system 12 does not indicate that an elevator system (not specifically shown in FIG. 3) is misleveled. If the sensor 18 stops sensing the laser beam 19—or if the sensed amplitude of the laser beam 19 falls below a pre-determined threshold (e.g., 90%, 75%, 50%, or 25%)—then the sensor board 15 relays a NOT SENSING signal 39 to the controller 14, and the elevator level warning system 12 indicates that an elevator system (not specifically shown in FIG. 3) is misleveled.

The controller 14 is coupled to and controls an indicator 24—e.g., a visual indicator 22, an audio indicator 23, or both (or any combination of multiples of either or both). In the embodiment shown in FIG. 3, the elevator level warning system has one visual indicator 22 and one audio indicator 23. But other embodiments have other combinations of visual indicators and audio indicators (or of either).

The visual indicator 22 may be any suitable visual indicator. For example, the visual indicator 22 might be a steady light, a flashing light, a strobe light, a lighted sign, a spotlight, an annunciator panel, an LED strip, or any combination of the foregoing.

The audio indicator 23 may be any suitable audio indicator. For example, the audio indicator 23 might be a speaker, an annunciator (e.g., a voice annunciator), a horn, a klaxon, a buzzer, a bell, a whistle, or a siren. In some embodiments, the audio indicator 23 is a voice annunciator configured to deliver a message to a user (which message the voice annunciator might be configured to repeat at regular intervals). The message may be any suitable message. In addition, the message may be in any suitable language or code. One nonlimiting example of such a message is “Warning: watch your step; a trip hazard exists.” Another nonlimiting example of such a message is: “Warning: misleveling event.” In some embodiments, the voice annunciator might store the message in electric, magnetic, or electronic memory—for example, in a memory configured to store up to approximately 256 kilobytes of digital information or in a memory configured to store up to approximately 512 kilobytes of digital information.

The indicator 24—including the audio indicator 23 and/or the visual indicator 22—may be positioned in any suitable location. In some embodiments, the indicator 24 is wholly, substantially, or partially remote from the elevator system—e.g., in a control room. In some embodiments, the indicator 24 is positioned wholly, substantially, or partially within the cab 2-e.g., in a ceiling of the cab 2. In some embodiments, the indicator 24 is positioned wholly, substantially, or partially within a hallway or foyer in the building—e.g., near the landing 8.

If the controller 14 receives a NOT SENSING signal 39 while the cab door 4 is open, then the controller 14 activates the indicator 24 (e.g., the visual indicator 22 and the audio indicator 23). The indicator 24 (e.g., the visual indicator 22 and the audio indicator 23) remain activated until the cab door 4 closes; the closing of the cab door 4 deactivates the indicator 24 (e.g., the visual indicator 22 and the audio indicator 23).

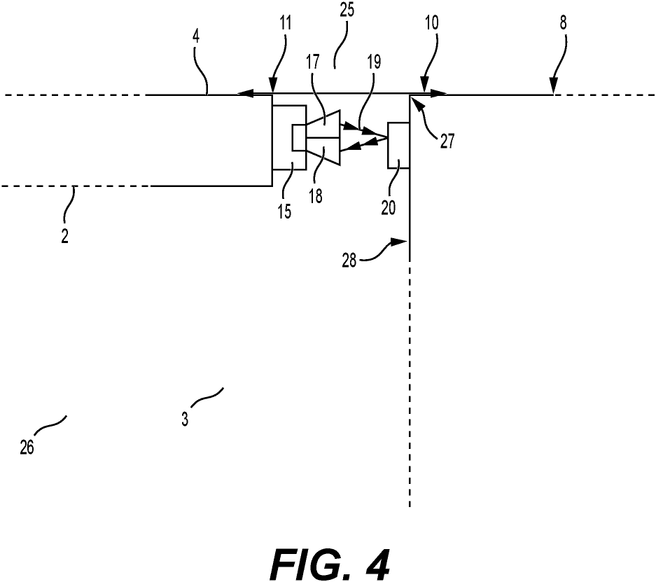

FIG. 4 is a partial side view of an elevator level warning system 25 and an elevator system 26, as leveled. The sensor board 15 is positioned on the cab floor 4. The reflector 20 is positioned on the wall 28 of the hoistway 3. The reflector 20 is fastened to the wall 28 using any suitable fastener (not specifically shown in FIG. 4)—for example double-sided tape. One example of double sided tape is 3M™ VHB™ tape (available from 3M at <https://www.3m.com/3M/en_US/vhb-tapes-us/> [accessed on Sep. 19, 2022; archived at <https://web.archive.org/web/20220831223235/https://www.3m.com/3M/en_US/vhb-tapes-us/>]). The reflector 20 is positioned proximate the landing front edge 27. The laser 17, reflector 20, and sensor 18 are positioned and oriented such that the laser 17 produces the laser beam 19 which is reflected by the reflector 20 onto the sensor 18.

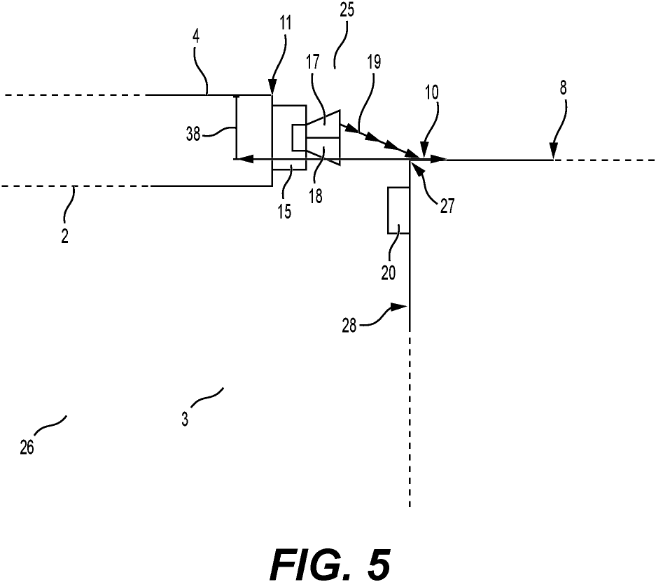

FIG. 5 is a partial side view of an elevator level warning system 25 and an elevator system 26, as misleveled. In FIG. 5 the front cab-floor edge 11 is above the landing plane 10. The drop 38 is large enough that the laser beam 19 is not reflected by the reflector 20 onto the sensor 18; thus the sensor 18 stops sensing the laser beam 19, and then the sensor board 15 relays a NOT SENSING signal (e.g., the NOT SENSING signal 39 shown in FIG. 3) to the controller 14.

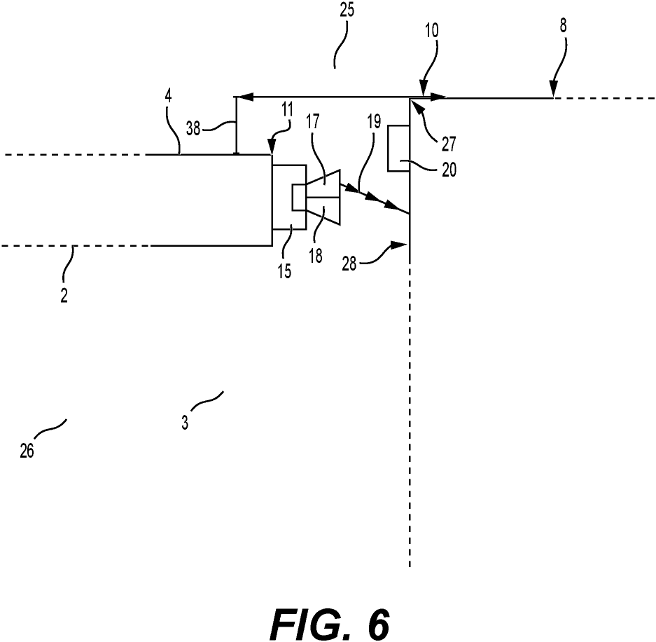

FIG. 6 is a partial side view of an elevator level warning system 25 and an elevator system 26, as misleveled. In FIG. 6 the front cab-floor edge 11 is below the landing plane 10. The drop 38 is large enough that the laser beam 19 is not reflected by the reflector 20 onto the sensor 18; thus the sensor 18 stops sensing the laser beam 19, and then the sensor board 15 relays a NOT SENSING signal (e.g., the NOT SENSING signal 39 shown in FIG. 3) to the controller 14.

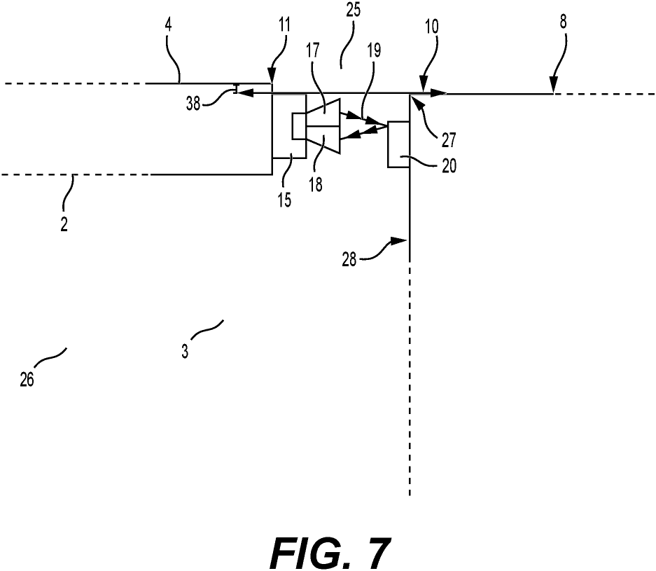

FIG. 7 is a partial side view of an elevator level warning system 25 and an elevator system 26, as misleveled. In FIG. 7 the front cab-floor edge 11 is above the landing plane 10. The drop 38 is small enough that the laser beam 19 is yet reflected by the reflector 20 onto the sensor 18; thus the sensor 18 yet senses the laser beam 19, and the sensor board 15 does not relay any NOT SENSING signal to the controller 14.

Similarly, it can happen that, when the front cab-floor edge 11 is below the landing plane 10, the drop 38 is small enough that the laser beam 19 is yet reflected by the reflector 20 onto the sensor 18; thus the sensor 18 would yet sense the laser beam 19, and the sensor board 15 would not relay any NOT SENSING signal to the controller 14. But this scenario is not specifically shown in FIG. 7.

FIG. 8A is a perspective view of a structured reflector 29. A structured reflector 29 is made of a substantially rigid material (e.g., metal or plastic). A structured reflector 29 has a reflecting surface 30 that is configured to reflect a laser beam (e.g., laser beam 19 [not specifically shown in FIG. 8A])—for example, by being wholly, substantially, or partially covered with reflective tape (not specifically shown in FIG. 8A).

The reflecting surface 30 has a height 40. The height 40 determines the size of the drop 38 that causes the sensor board 15 to send a NOT SENSING signal 39 to the controller 14. In one exemplary embodiment, the height 40 may be approximately 1.0 inch; thus a drop 38 of greater than approximately 0.50 inches would cause the sensor board 15 to send a NOT SENSING signal 39 to the controller 14. In another exemplary embodiment, the height 40 may be approximately 0.50 inches; thus a drop 38 of greater than approximately 0.25 inches would cause the sensor board 15 to send a NOT SENSING signal 39 to the controller 14. In another exemplary embodiment, the height 40 may be approximately 0.25 inch; thus a drop 38 of greater than approximately 0.13 inches would cause the sensor board 15 to send a NOT SENSING signal 39 to the controller 14. In another exemplary embodiment, the height 40 may be approximately 0.13 inch; thus a drop 38 of greater than approximately 0.07 inches would cause the sensor board 15 to send a NOT SENSING signal 39 to the controller 14. In general, a drop 38 of greater than approximately half the height 40 would cause the sensor board 15 to send a NOT SENSING signal 39 to the controller 14.

The structured reflector 29 may have any suitable shape. In the embodiment shown in FIG. 8A, the structured reflector 29 has a back surface 31, a first front non-reflecting surface 32, the reflecting surface 30, and a second front non-reflecting surface 33. The first front non-reflecting surface 32 and the second front non-reflecting surface 33 are positioned in one plane which is different from—and parallel to—the plane of the reflecting surface 30. In some embodiments, the first front non-reflecting surface 32 and the second front non-reflecting surface 33 are less reflective of the laser beam 19 than is the reflecting surface 30; in some embodiments, the first front non-reflecting surface 32 and the second front non-reflecting surface 33 are wholly, substantially, or partially non-reflective of the laser beam 19. In some embodiments the first front non-reflecting surface 32 and the second front non-reflecting surface 33 are less reflective—or wholly, substantially, or partially non-reflective—of the laser beam 19 because they wholly, substantially, or partially absorb the laser beam 19; in some embodiments the first front non-reflecting surface 32 and the second front non-reflecting surface 33 are less reflective—or wholly, substantially, or partially non-reflective—of the laser beam 19 because they wholly, substantially, or partially scatter the laser beam 19. The first front non-reflecting surface 32 is connected to the reflecting surface by a first oblique surface 34. The second front non-reflecting surface 32 is connected to the reflecting surface by a second oblique surface 35. The structured reflector 29 has a left face 36 and a right face 37. The structured reflector 29 is shaped substantially as a right prism having the left face 36 and the right face 37 as its bases.

FIG. 8B is a top view of a structured reflector 29.

FIG. 8C is a front view of structured reflector 29.

FIG. 8D is a side view of a structured reflector 29.

While the foregoing specification has described specific embodiments of this invention and many details have been put forth for the purpose of illustration or example, it will be apparent to one skilled in the art that the invention is susceptible to additional embodiments and that certain of the details described herein can be varied considerably without departing from the basic principles of the invention.

We claim:

1. An elevator level warning system comprising:
a controller coupled to and powered by a power source;
a sensor board coupled to the controller and having at least one sensor mount connected to (i) a laser that is capable of producing a laser beam and (ii) a sensor that is capable of sensing the laser beam; and
a reflector capable of reflecting the laser beam to the sensor,
wherein the reflector is oriented with respect to the laser and sensor such that:
when a drop between the reflector and the sensor is less than a threshold distance, (1) the reflector substantially reflects the laser beam to the sensor and (2) the sensor senses the laser beam, and,
when the drop is not less than the threshold distance, (1) the reflector does not substantially reflect the laser beam to the sensor and (2) the sensor does not sense the laser beam.

2. The elevator level warning system of claim 1, wherein, when the reflector does not substantially reflect the laser beam to the sensor:
the sensor board relays a NOT SENSING signal to the controller, and
the controller receives the NOT SENSING signal.

3. The elevator level warning system of claim 2, wherein, when the controller receives the NOT SENSING signal, the controller activates an indicator coupled to the controller.

4. The elevator level warning system of claim 3, wherein the indicator comprises a visual indicator.

5. The elevator level warning system of claim 3, wherein the indicator comprises an audio indicator.

6. The elevator level warning system of claim 5, wherein the audio indicator comprises a voice annunciator configured to deliver a message when activated.

7. The elevator level warning system of claim 1, wherein the reflector comprises a structured reflector.

8. The elevator level warning system of claim 7, wherein the structured reflector comprises:
a reflecting surface having a height;
an oblique surface; and
a front non-reflecting surface connected to the reflecting surface by the oblique surface.

9. The elevator level warning system of claim 8, wherein the height is approximately twice the threshold distance.

10. The elevator level warning system of claim 8, wherein the reflective surface is partially covered by a reflective tape.

11. The elevator level warning system of claim 1, wherein the sensor is configured to sense the laser beam substantially to the exclusion of other light sources.

12. An elevator level warning system, for use with an elevator system having a landing (which defines a landing plane and has a landing front edge) and a front cab-floor edge, comprising:
a controller coupled to and powered by a power source;
a sensor board coupled to the controller and having at least one sensor mount connected to (i) a laser that is capable of producing a laser beam and (ii) a sensor that is capable of sensing the laser beam; and
a reflector capable of reflecting the laser beam to the sensor;
wherein (1) the laser and sensor are positioned with respect to the front cab-floor edge, (2) the reflector is positioned with respect to the landing front edge, and (3) the reflector is oriented with respect to the laser and sensor, such that:
when a drop between the front cab-floor edge and the landing plane is less than a threshold distance, (A) the reflector substantially reflects the laser beam to the sensor and (B) the sensor senses the laser beam, and,
when the drop is not less than the threshold distance, (A) the reflector does not substantially reflect the laser beam to the sensor and (B) the sensor does not sense the laser beam.

13. The elevator level warning system of claim 12, wherein, when the reflector does not substantially reflect the laser beam to the sensor, the controller activates an indicator coupled to the controller.

14. The elevator level warning system of claim 13, wherein the indicator comprises an audio indicator configured to deliver a message when activated.

15. The elevator level warning system of claim 12, wherein the reflector is a structured reflector comprising a reflecting surface having a height.

16. The elevator level warning system of claim 15, wherein the height is approximately twice the threshold distance.

17. The elevator level warning system of claim 12, wherein the threshold distance is less than or equal to approximately 0.25 inch.

18. The elevator level warning system of claim 17, wherein the threshold distance is less than or equal to approximately 0.13 inch.

19. A structured reflector for use in an elevator level warning system, comprising:
a reflecting surface having a height and capable of reflecting a laser beam;
a first oblique surface; and
a first front non-reflecting surface connected to the reflecting surface by the first oblique surface.

20. The structured reflector of claim 19, further comprising:
a second oblique surface;
a second front non-reflecting surface connected to the reflecting surface by the second oblique surface;
a left face; and
a right face;
wherein the structured reflector is shaped substantially as a right prism,
wherein the left face and the right face are bases of the right prism; and wherein the height is of nor more than approximately 0.50 inch.
